(19) United States
(12) Patent Application Publication
(10) Pub. No.: US 2009/0098893 A1
(43) Pub. Date: Apr. 16, 2009

(54) REAL-TIME INTERACTING METHOD FOR MOBILE COMMUNICATIONS DEVICES

(76) Inventor: Chi-Jen Huang, Taipei (TW)

Correspondence Address: Muncy, Geissler, Olds & Lowe, PLLC, P.O. BOX 1364, FAIRFAX, VA, 22038-1364, US

(21) Appl. No.: 12/246,041

(22) Filed: Oct. 6, 2008

(30) Foreign Application Priority Data
Oct. 12, 2007 (TW) 096138338

(51) Int. Cl. H04W 4/00

(52) U.S. Cl. 455/466

(57) ABSTRACT

A real-time interacting method for mobile communication devices involves creating an interactive area thereon, inputting an interactive message via handwriting, and capturing a synchronous audio message, so that the mobile communication devices transmit/receive the interactive message and the audio message via a 3G communication link to achieve real-time interaction.

This application claims the benefit of Taiwan Patent Application No. 096138338, filed on Oct. 12, 2007, which is hereby incorporated by reference for all purposes as if fully set forth herein.

### BACKGROUND OF THE INVENTION

1. Field of Invention

The present invention relates to a real-time interacting method, in particular to a method for mobile communication devices to perform real-time interaction by utilizing handwriting on a touch screen and audio.

2. Related Art

With the rapid development of industry and commerce in recent years, many affairs require collective discussion by relevant personnel for whom travel is very time-consuming. Advances in mobile communication technology have made possible real-time discussion by transmitting video and audio via 3G communications. Some discussions, however, involve documents with images and tables, which are more difficult to be well understood by simply using video and audio.

For example, when detailed discussion on some field in a table or some part of an image is required, it always takes a long time to communicate and understand the messages that each wants to convey, which tends to lower communication efficiency and usually results in many inconveniences brought on by the miscommunication of information.

### SUMMARY OF THE INVENTION

In view of the above, the present invention provides a real-time interacting method for mobile communication devices to solve these problems.

The present invention discloses a real-time interacting method for mobile communication devices, wherein when real-time interaction is performed between a user and a discussant, the user manipulates a touch screen of a mobile communication device to execute a real-time interacting function. Upon executing the function, the user further chooses to perform the real-time interaction in a text mode or an image mode. If the interaction is performed in the text mode, an interactive text area is created onto which the user inputs an interactive message via handwriting on the touch screen and the handwriting is automatically recognized as an interactive text message. If the interaction is performed in the image mode, an interactive image area is created onto which the user inputs the interactive message via handwriting to generate an interactive handwriting image message. At the same time, the mobile communication device utilizes an audio signal capturing module to capture an audio message from the user. The interactive text message or the interactive handwriting image message is transmitted to the discussant through a communication module of the mobile communication device via a 3G communication link.

Similar to these steps, the discussant may also transmit an interactive message to the user, so that the user and the discussant are able to synchronously transmit/receive the interactive messages to/from each other in real time, thereby achieving real-time interaction.

The real-time interacting method for mobile communication devices according to the present invention amends the shortcomings of mobile communications that use audio and video to transmit interactive messages, which tend to result in the miscommunication of information, and enhances the efficiency and pleasure of communication for both interactive parties by utilizing handwriting on a touch screen and transmitting/receiving interactive messages via the 3G communication link.

### BRIEF DESCRIPTION OF THE DRAWINGS

The present invention will become more fully understood from the detailed description given herein below for illustration only, and which thus is not limitative of the present invention, and wherein:

FIG. 1 is a schematic view of an embodiment of the real-time interacting method for mobile communication devices according to the present invention;

FIG. 2A is a structural block diagram of a first mobile communication device of the embodiment of the real-time interacting method for mobile communication devices according to the present invention;

FIG. 2B is a structural block diagram of a second mobile communication device of the embodiment of the real-time interacting method for mobile communication devices according to the present invention;

FIG. 3 is a flowchart of the embodiment of the real-time interacting method for mobile communication devices according to the present invention;

FIG. 4A is a schematic view of the text mode of the embodiment of the real-time interacting method for mobile communication devices according to the present invention;

FIG. 4B is a schematic view of the text mode of the embodiment of the real-time interacting method for mobile communication devices according to the present invention;

FIG. 4C is a schematic view of the image mode of the embodiment of the real-time interacting method for mobile communication devices according to the present invention used in drawing interaction; and

FIG. 4D is a schematic view of the image mode of the embodiment of the real-time interacting method for mobile communication devices according to the present invention used in map illustration.

### DETAILED DESCRIPTION OF THE INVENTION

Hereinafter, a detailed description is given in connection with embodiments and drawings for further understanding of the subject matter of the present invention.

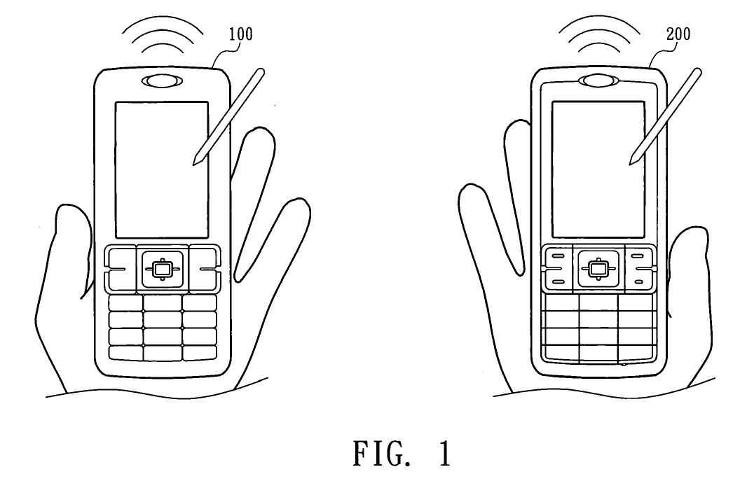

Referring to FIG. 1, it is a schematic view of an embodiment of the real-time interacting method for mobile communication devices disclosed by the present invention. As shown in FIG. 1, real-time interaction is performed between the user of a first mobile communication device 100 and the discussant of a second mobile communication device 200 via a 3G communication link.

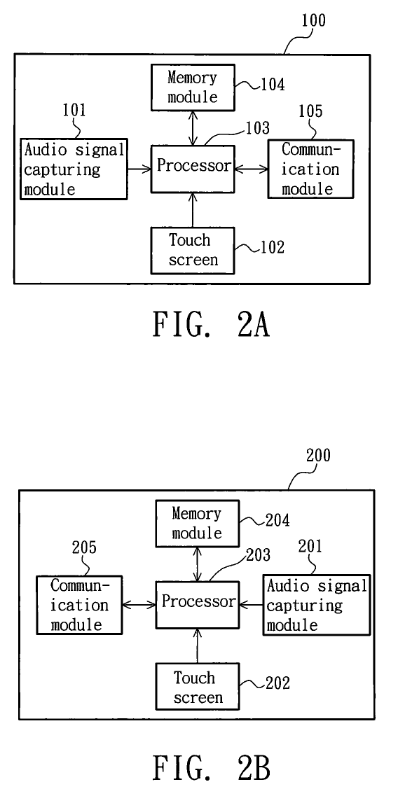

Referring to FIG. 2A, it is a structural block diagram of the first mobile communication device 100 of the embodiment of the real-time interacting method for mobile communication devices disclosed by the present invention. As shown in FIG. 2A, the first mobile communication device 100 comprises an audio signal capturing module 101, a touch screen 102, a processor 103, a memory module 104, and a communication module 105. Referring to FIG. 2B, it is a structural block diagram of the second mobile communication device 200 of the embodiment of the real-time interacting method for mobile communication devices disclosed by the present invention. As shown in FIG. 2B, the second mobile communication device 200 comprises an audio signal capturing module 201, a touch screen 202, a processor 203, a memory module 204, and a communication module 205.

When the real-time interaction is performed between the user and the discussant, a real-time interacting function of the first mobile communication device 100 and the second mobile communication device 200 will be initiated simultaneously. If the user launches an interactive discussion, the user will manipulate the touch screen 102 of the first mobile communication device 100 to send a command for controlling the processor 103 of the first mobile communication device 100 to activate an interactive area. The user inputs an interactive message onto the interactive area on the touch screen 102 of the first mobile communication device 100 via handwriting on the touch screen 102 and simultaneously manipulates the audio signal capturing module 101 of the first mobile communication device 100 to capture an audio message synchronously, thereby enhancing pleasure during the real-time interaction and facilitating accurate communication through the transmission of the messages.

The communication module 105 of the first mobile communication device 100 transmits the interactive message and the audio message to the second mobile communication device 200 via the 3G communication link, so that the discussant of the second mobile communication device 200 is able to synchronously receive the interactive message and the audio message transmitted by the user in real time.

Similar to the aforementioned operation of the user launching the interactive discussion, the discussant of the second mobile communication device 200 may also synchronously launch an interactive discussion and transmit an interactive message and an audio message to the first mobile communication device 100, so that the first mobile communication device 100 and the second mobile communication device 200 are able to synchronously transmit/receive the interactive messages to/from each other in real time, thereby achieving the real-time interaction.

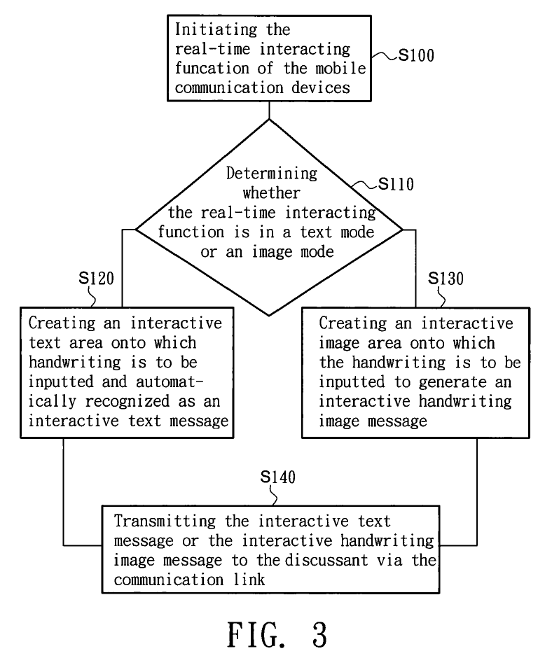

Referring to FIG. 3, it is a flowchart of the embodiment of the real-time interacting method for mobile communication devices disclosed by the present invention. The steps are as follows:

Initiate the real-time interacting function of the mobile communication devices (step S100). When the real-time interaction is performed between the user and the discussant, the user manipulates an operating system menu of the first mobile communication device 100 via the touch screen 102 of the first mobile communication device 100 to execute the real-time interacting function. At this time, the memory module 104 of the first mobile communication device 100 loads a real-time interacting system program for the mobile communication devices. A message is displayed on the touch screen 102 of the first mobile communication device 100 to request the user input the information of the discussant, so that the first mobile communication device 100 is able to correctly communicate with the discussant for performing the real-time interaction.

Determine whether the real-time interacting function is in a text mode or an image mode (step S110). After the real-time interacting function is executed by the user via the touch screen 102 of the first mobile communication device 100, the processor 103 of the first mobile communication device 100 further determines that the real-time interaction is to be performed in the text mode or the image mode.

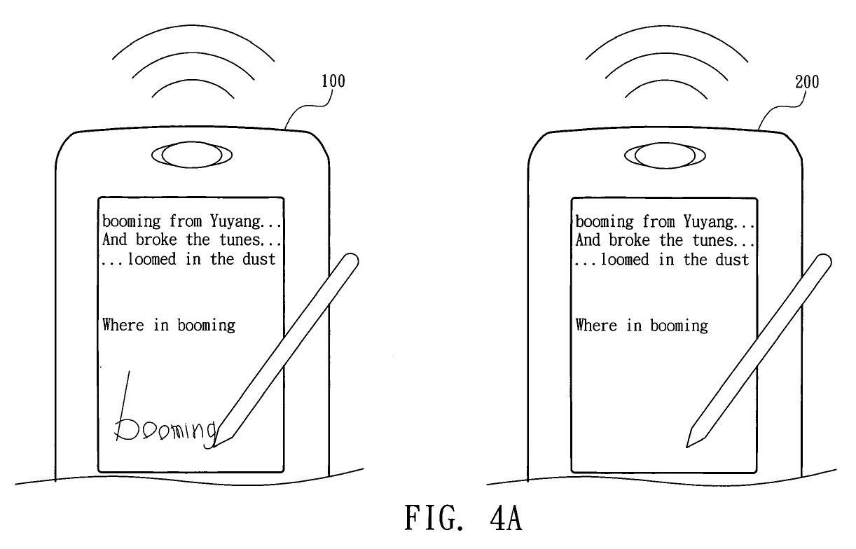

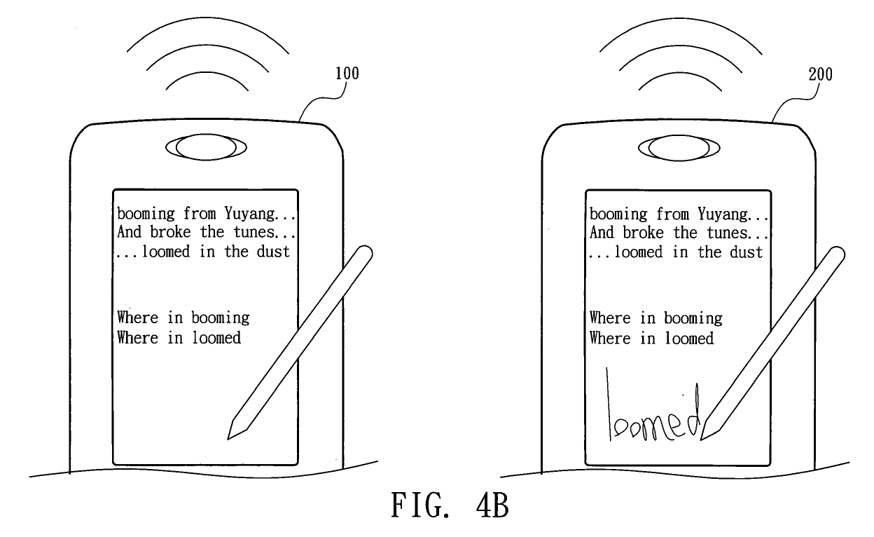

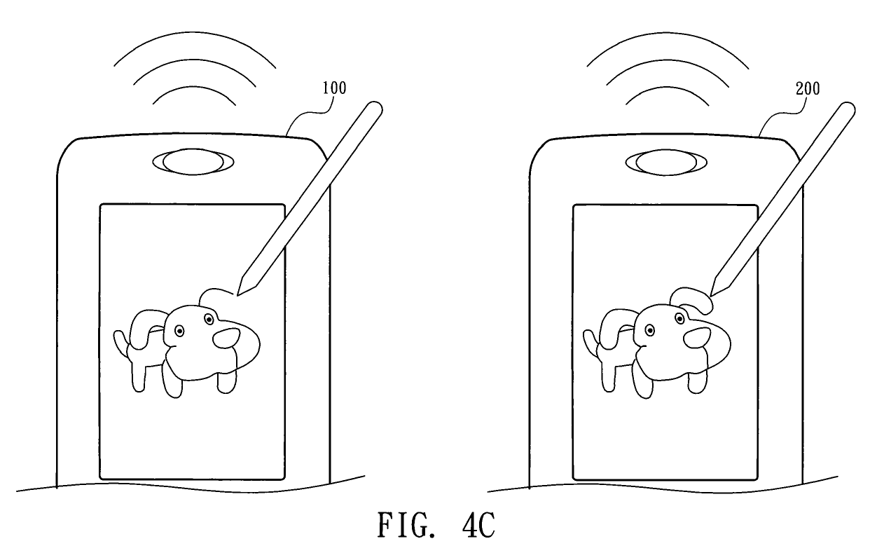

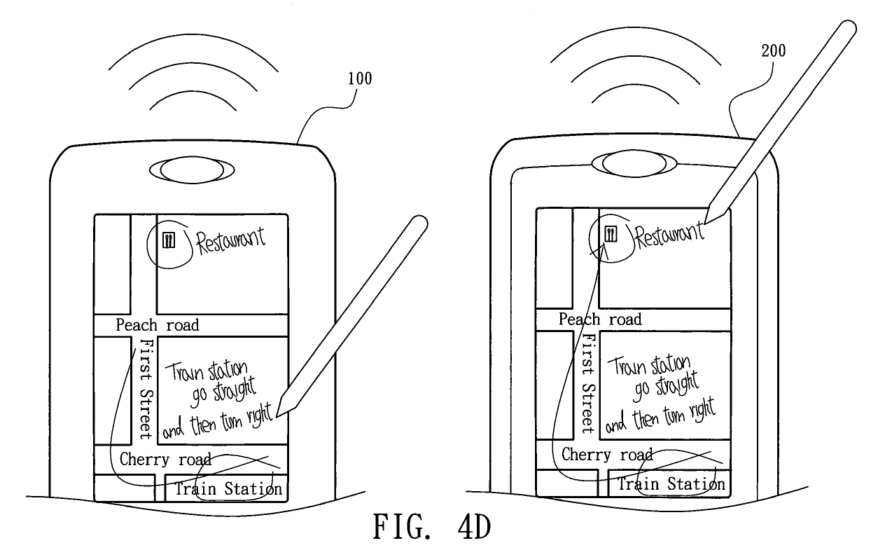

Referring to FIGS. 4A to 4D collectively for better understanding, FIGS. 4A and 4B are schematic views of the text mode of the embodiment of the real-time interacting method for mobile communication devices according to the present invention. FIG. 4C is a schematic view of the image mode of the embodiment of the real-time interacting method for mobile communication devices according to the present invention used in drawing interaction. FIG. 4D is a schematic view of the image mode of the embodiment of the real-time interacting method for mobile communication devices according to the present invention used in map illustration.

When the real-time interacting function is in the text mode, create an interactive text area onto which handwriting is to be inputted and automatically recognized as an interactive text message (step S120). The text mode includes creating the interactive text area on the touch screen 102 by the processor 103 of the first mobile communication device 100, and loading a text recognizing program from the memory module 104 of the first mobile communication device 100; when the user inputs the handwriting onto the interactive text area, the processor 103 of the first mobile communication device 100 utilizes the text recognizing program to automatically recognize the handwriting, then a corresponding interactive text message is generated and synchronously displayed on the interactive text area created on the touch screen 102 of the first mobile communication device 100 for performing the real-time interaction between the user and the discussant. In the real-time interaction, the text mode allows the interaction to be performed utilizing text for improving the precision of transmission of the messages during the interaction when the ideas of both parties cannot be clearly expressed orally or some complicated characters such as “loomed” and “booming” are to be expressed.

When the real-time interacting function is in the image mode, create an interactive image area onto which the handwriting is to be inputted to generate an interactive handwriting image message (step S130). The image mode includes creating the interactive image area on the touch screen 102 by the processor 103 of the first mobile communication device 100; when the user inputs the handwriting, the handwriting is recognized by the processor 103 of the first mobile communication device 100 and converted into a digital signal, which is then superimposed on the relative image positions to generate a handwriting image, and the handwriting image is synchronously displayed on the interactive image area created on the touch screen 102 of the first mobile communication device 100 for performing the real-time interaction between the user and the discussant.

In the text mode and image mode, the first mobile communication device 100 further utilizes the audio signal capturing module 101 to synchronously capture the audio message from the user.

Transmit the interactive text message or the interactive handwriting image message to the discussant via the communication link (step S140). In the text mode, the processor 103 of the first mobile communication device 100 controls the communication module 105 to transmit the interactive text message in the interactive text area on the touch screen 102 and the audio message from the user synchronously captured by the audio signal capturing module 101 to the second mobile communication device 200 via the 3G communication link, so that the discussant of the second mobile communication device 200 is able to synchronously receive the interactive text message and the audio message transmitted by the user of the first mobile communication device 100 in real time.

In the image mode, the processor 103 of the first mobile communication device 100 controls the communication module 105 to transmit the interactive handwriting image message in the interactive image area on the touch screen 102 and the audio message from the user synchronously captured by the audio signal capturing module 101 to the second mobile communication device 200 via the 3G communication link, so that the discussant of the second mobile communication device 200 is able to synchronously receive the interactive image message and the audio message transmitted by the user of the first mobile communication device 100 in real time.

The processor 103 of the first mobile communication device 100 controls the communication module 105 of the first mobile communication device 100 to transmit the interactive handwriting image message on the interactive image area on the touch screen 102 of the first mobile communication device 100 only at the first transmission. After the first transmission, the processor 103 of the first mobile communication device 100 will only recognize the handwriting and the relative positions thereof shown on the interactive handwriting image message. The information is converted into a digital signal which is then transmitted to the second mobile communication device 200 via the communication module 105 of the first mobile communication device 100, and the processor 203 in the second mobile communication device 200 is utilized to convert the digital signal into a corresponding handwriting and the relative positions thereof shown on the interactive handwriting image message. The converted corresponding handwriting and the relative positions thereof are displayed on the interactive image area on the touch screen 202 of the second mobile communication device 200. Accordingly, the transmission rate is increased. Similar to the steps of the embodiment of the first mobile communication device 100 transmitting the interactive messages, the second mobile communication device 200 may also transmit the interactive message and the audio message in accordance with the steps of the embodiment thereof, so that the first mobile communication device 100 and the second mobile communication device 200 are able to synchronously transmit/receive the interactive messages to/from each other in real time, thereby achieving the real-time interaction. The interactive messages from each other may also be stored by the memory module 104 of the first mobile communication device 100 or the memory module 204 of the second mobile communication device 200 for future use.

To sum up, in the real-time interacting method for mobile communication devices according to the present invention, the text mode or the image mode includes creating the text message or the handwriting image via real-time handwriting on a touch screen to transmit the messages from both interactive parties. The difference between the two lies in that the text mode involves automatically recognizing the character type of the handwriting by the recognizing program of the mobile communication devices after the handwriting is inputted to perform interaction between both parties. For example, FIGS. 4A and 4B illustrate the interaction between the mobile communication devices in the text mode.

Concerning the image mode, the mobile communication devices utilize the format of the handwriting and the relative positions thereof after the handwriting is inputted from the touch screen to perform interaction between both parties. For example, FIGS. 4C and 4D illustrate the interaction between the mobile communication devices in the image mode, wherein the characters shown in FIG. 4D indicate that the format of the handwriting and the relative positions thereof are different from those in FIGS. 4A and 4B.

The present invention amends the shortcomings of mobile communications that use audio and video to transmit interactive messages, which tend to result in the miscommunication of information, and enhances the efficiency and pleasure of communication for both interactive parties.

The preferred embodiments of the present invention have been disclosed in the examples. However the examples should not be construed as a limitation on the actual applicable scope of the invention, and as such, all modifications and alterations without departing from the spirits of the invention and appended claims shall be within the scope and claims of the invention.

What is claimed is:

1. A real-time interacting method for mobile communication devices, in which an interactive message is transmitted from a user to a discussant via a communication link to perform real-time interaction, the real-time interacting method comprises:
initiating a real-time interacting function of the mobile communication devices;
determining whether the real-time interacting function is in a text mode or an image mode;
when the real-time interacting function is in the text mode, creating an interactive text area onto which handwriting is to be inputted and automatically recognized as an interactive text message;
when the real-time interacting function is in the image mode, creating an interactive image area onto which handwriting is to be inputted to generate an interactive handwriting image message; and
transmitting the interactive text message or the interactive handwriting image message to the discussant via the communication link.

2. The real-time interacting method for mobile communication devices according to claim 1, wherein the interactive message obtained by the user and the discussant is provided by each other.

3. The real-time interacting method for mobile communication devices according to claim 1, wherein the user and the discussant obtain the identical interactive message.

4. The real-time interacting method for mobile communication devices according to claim 1, wherein when the real-time interacting function is in the text mode, the step of creating the interactive text area onto which the handwriting is to be inputted and automatically recognized as the interactive text message further comprises:
capturing a synchronous audio message.

5. The real-time interacting method for mobile communication devices according to claim 1, wherein when the real-time interacting function is in the image mode, the step of creating the interactive image area onto which the handwriting is to be inputted to generate the interactive handwriting image message further comprises:
capturing a synchronous audio message.

6. The real-time interacting method for mobile communication devices according to claim 1, wherein the mobile communication devices further store the interactive messages from the user and the discussant.

7. The real-time interacting method for mobile communication devices according to claim 1, wherein the real-time interaction is performed between the user and the discussant via a 3G communication link.
